(19) United States
(12) Patent Application Publication
(10) Pub. No.: US 2023/0043515 A1
(43) Pub. Date: Feb. 9, 2023

(54) REMOTE TEMPERATURE MEASUREMENT OF COOKWARE THROUGH A CERAMIC GLASS PLATE USING AN INFRARED SENSOR

(71) Applicant: ELATRONIC AG, Engelburg (CH)

(72) Inventors: Heinrich Weder, Engelburg (CH); Reto Keller, Goldach (CH); Werner Meier, Herrliberg (CH)

(73) Assignee: ELATRONIC AG, Engelburg (CH)

(21) Appl. No.: 16/401,169

(22) Filed: May 2, 2019

Related U.S. Application Data
(60) Provisional application No. 62/665,589, filed on May 2, 2018.

(51) Int. Cl. G01K 11/00; G01J 5/80

(52) U.S. Cl. CPC G01K 11/00; G01J 5/80; G01K 2207/06

(57) ABSTRACT

Remote temperature measurement of cookware through a ceramic glass plate using an infrared sensor, taking into account the emissivity of the cookware which is continuously evaluated, and taking into account the temperature of the ceramic glass plate.

### CROSS REFERENCE TO RELATED APPLICATIONS

This application claims the benefit of U.S. Provisional Application No. 62/665,589, filed May 2, 2018, entitled: REMOTE TEMPERATURE MEASUREMENT OF COOKWARE THROUGH A CERAMIC GLASS PLATE USING AN INFRARED SENSOR, the content of which is incorporated herein by reference and relied upon.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### FIELD OF THE INVENTION

The invention relates to a system and method for temperature measurement and control, preferably used in an induction heating system for cooking.

### BACKGROUND OF THE INVENTION

The measurement of the thermal radiation of objects in the infrared range to determine their temperature has been known for a long time and is widely used. A method for the indirect measurement and control of cookware with the help of temperature sensors for heating coil protection has also been employed for many years. This method has, however, the disadvantage that the inertia of the temperature sensors provides delayed information on the temperature of the cookware, because heat must first be conducted across the ceramic glass plate which evidently takes time. Moreover, such a method is subject to errors in the absence of a planar bottom of the cookware.

The use of an infrared sensor with a spectral response suitable for the measurement of cookware temperature through a ceramic glass plate has been described for example in the publication titled Infrared Sensor-Based Temperature Control for Domestic Induction Cooktops, Javier Lasobras et al., ISSN 1424-8220, the content of which is incorporated herein by reference thereto. In this publication, any possible dependence of the emissivity of a pan on its position on the stove has been neglected. Such a dependence may arise for example as a result of inhomogeneous optical properties of the bottom of the pan. Moreover, the influence of the temperature of the ceramic glass plate itself has not been taken into account, although this temperature may greatly vary, depending on whether or not the stove has been in use with another pan before.

Measurement of temperature of cookware may be performed via a separate, handheld infrared sensor with the infrared beam pointed directly at the cookware. However, this is not convenient because the device must be stored next to the induction plate, taken by hand, aimed and read, and then replaced in its usual stored position.

Use of an infrared sensor for measuring temperature of cookware would be advantageous, but measurement through a ceramic glass plate supporting the cookware has not been satisfactorily realized using an infrared sensor. However, such use, if a consistent and reliable and accurate result may be obtained, would clearly be desirable.

What is needed therefore is a device using an infrared sensor permanently affixed and readily activated for reading temperature, and which can accurately read temperature through the ceramic glass plate.

### SUMMARY OF THE INVENTION

The invention provides for remote measurement of temperature of cookware through a ceramic glass plate by means of an infrared sensor, taking into account the emissivity of the cookware which is continuously evaluated, and taking into account the temperature of the ceramic glass plate. The device includes an infrared sensor disposed below an induction coil and a ceramic glass plate supporting the cookware, the device using continuously registered inputs of the emissivity of the cookware and of the temperature of the ceramic glass plate in order to accurately evaluate the temperature of the cookware.

It is an object of this invention to provide accurate temperature control of cookware during cooking with a glass ceramic stove.

It is an object of the invention to permit faster control of the temperature of cookware on a glass ceramic hob during heating and cooking.

It is another object of the invention to permit fast control of the temperature of cookware even when cooking with high power.

It is yet another object of the invention to reliably protect the cookware against overheating.

### BRIEF DESCRIPTION OF THE DRAWINGS

FIG. 1A is a cross-sectional view of a glass ceramic hob containing the elements of an infrared measurement system of the invention, including the printed circuit board containing sensors and control electronics.

FIG. 1B is a top view of the printed circuit board containing sensors and control electronics.

FIG. 2 is a schematic view of a rotary knob for switching the method of temperature control between power and temperature regulation.

FIG. 3 is a block diagram of the control electronics of the invention.

FIG. 4 is a multi-hob cooking kitchen island of the invention.

FIG. 5 is a schematic diagram of a retrofit kit of the invention.

FIG. 6 is a schematic diagram of an alternate retrofit kit of the invention.

Those skilled in the art will appreciate that elements in the figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’, ‘top’ and ‘bottom’, and the like in the description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENTS

The following description is not intended to limit the scope of the invention in any way as they are exemplary in nature, serving to describe the best mode of the invention known to the inventors as of the filing date hereof. Consequently, changes may be made in the arrangement and/or function of any of the elements described in the exemplary embodiments disclosed herein without departing from the spirit and scope of the invention.

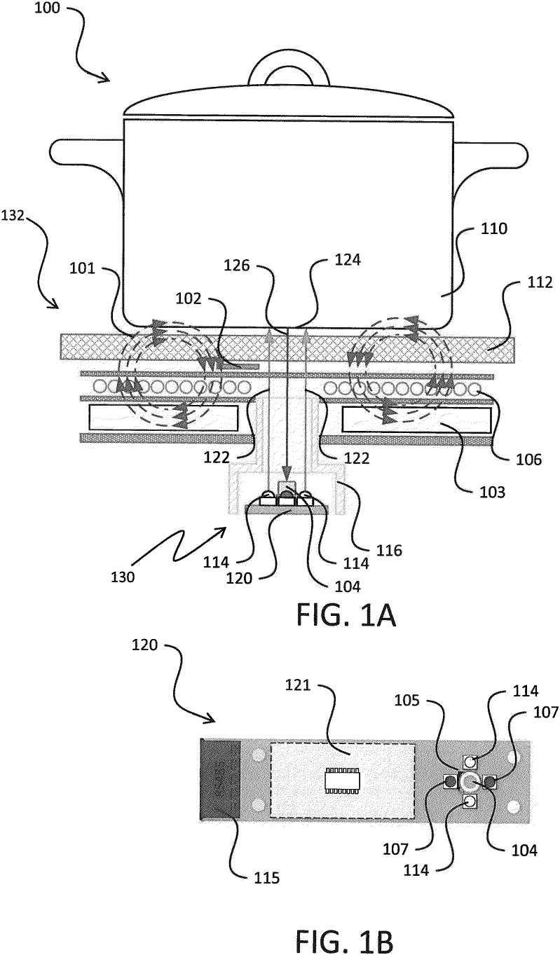

Referring now to FIGS. 1A and 1B, a glass ceramic hob 112 contains the elements of an infrared measurement system 130 of the invention. These elements include at least a printed circuit board 120 containing sensors 104, 308 and control electronics 121.

Cookware 110, or more precisely the metallic material from which cookware is made, is heated by alternating magnetic fields 101 in an induction stove 132 of the system 100 of the invention. Magnetic fields 101 are generated by induction coils 106 located underneath the hob 112. These magnetic fields 101 cause eddy currents to flow in the cookware, which as a result gets heated by Joule heating. The induction coils 106 are excited by resonant circuits driven by power electronics 134.

Power and temperature control are governed by control electronics 121 which also detects the presence of cookware 110 and which, together with e.g. a RS485 interface 115, 305, is located on a printed circuit board (PCB) 120 underneath the glass ceramic hob 112. The PCB hosts a thermistor 105, 306 close to infrared sensor 104 and two visible light LEDs 107 illuminating the center of the hob along with two infrared light emitting diodes (LEDs) 114 nearby. These LEDs 114 and the infrared sensor 104 are mounted so as to be isolated from infrared light sources (not shown) other than that of the object whose temperature is to be measured, particularly sources which vary in intensity over time. The control electronics 121 also controls the safety features which limit the maximum temperature. In order to guarantee safe operation, a temperature sensor 102 is located in between each inductor coil and the glass ceramic hob.

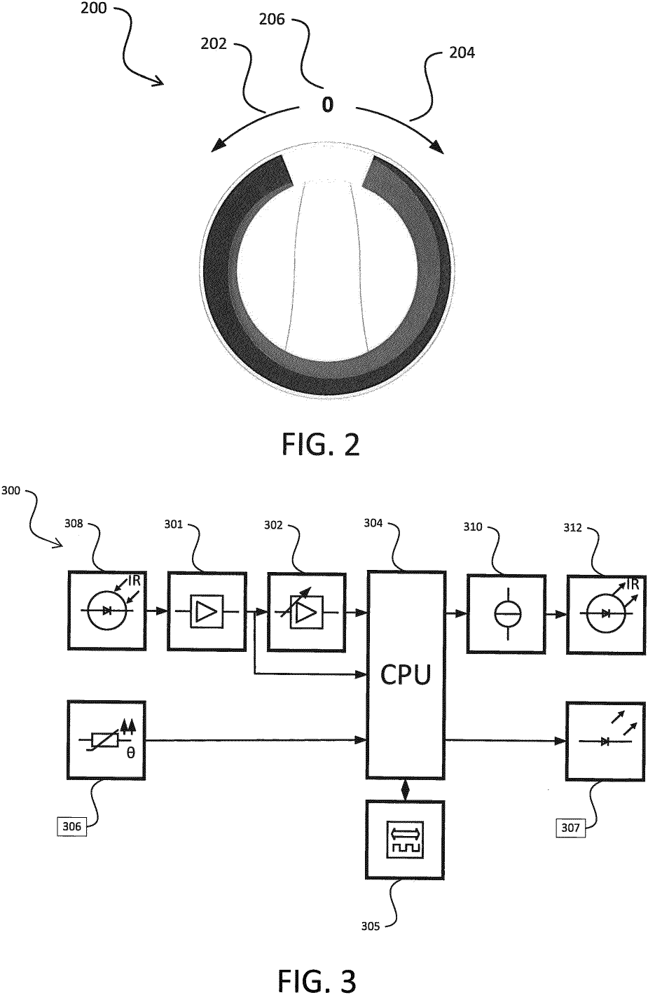

Referring now to FIG. 2, the control of ceramic glass hobs 112 is typically executed through a rotary knob 200 with which the power level or the temperature can be set. The off-position 206 is located for example at an angle of 0°. It is a characteristic feature of the invention that the power mode, chosen for example by a clockwise rotation 204 of the knob from the off-position 206, permits the power to be progressively changed. Increasing power levels can be indicated for example by numbers ranging from 1 to any number, for example 9.

A rotation of the knob 200 from the off-position in the opposite direction, for example a counter clockwise rotation 202, also activates the temperature mode. The temperature can be continuously set in this mode for example in the range from 70° C. to 250° C. Whenever the rotary knob 200 is rotated across the off-position 206 rapidly, for example not remaining in the off-position for more than one second, the current mode of operation remains unaltered. This functionality allows a fast adjustment of the power level or the temperature level respectively, without altering the mode of operation. This functionality further allows that the knob 200 be turned either clockwise or counter clockwise to a different level position, without altering the mode of operation.

Referring now to FIG. 3, a block diagram 300, the thermal radiation of the cookware 110 which is transmitted through the ceramic glass hob 112 is measured by an infrared sensor 104, 308 located on the PCB 120 below the inductor coil 106. The sensor 104, 308 is preferably a photodiode which is preferably highly sensitive at a wavelength of 2.3 µm. The spectral transmissivity of the ceramic glass, as provided by the hob manufacturer, is taken into account in the temperature measurement. Temperatures typically in the range of 70 to 350° C. are monitored by a two-stage amplifier unit with a first stage 301 and a second stage 302, both communicating with a microprocessor 304. The microprocessor records temperatures typically in the range of 70 to 350° C. and transmits them to the control electronics for example through a RS485 interface 115, 305 by means of a fieldbus or RS485 protocol. In order to compensate for the temperature characteristic of the infrared sensor 104, 308, an active temperature sensor (thermistor) 105, 306, or, alternatively, a passive temperature sensor, is located in its immediate vicinity. An enclosure 116, preferably made from aluminum, protects the infrared measurement system 130 from thermal and electromagnetic interference. The enclosure 116 further isolates the infrared sensor 104, 308 from infrared light sources (not shown) other than that of the object whose temperature is to be measured, particularly sources which vary in intensity over time.

The relevant emissivity for the remote temperature measurement by infrared radiation sensing cannot be defined as a single, constant value because of the use of different cookware 110. For example, a pan with a black bottom absorbs thermal radiation considerably more efficiently than pans with glossy bottoms. The optical properties of pans therefore significantly affect the measurement results.

The emissivity of cookware 110 can be determined by infrared light emitting diodes (LEDs) 114, 312 located close to the infrared sensor 104, 308. These infrared LEDs 114, 312 are switched on for a short time by a constant current provided by the constant current source 310. Infrared light 122 emitted by the LEDs is then transmitted through the ceramic glass plate of the hob 112 and reflected at the bottom 124 of the cookware 110. The reflected intensity 126 is detected by the infrared sensor 104, 308. The more infrared light is reflected back to the sensor, the higher the reflectance of the bottom 124 of the cookware 110 and hence the lower its emissivity. The spectral transmissivity of the ceramic glass plate, which is traversed both by the radiation emitted by the LEDs and by the radiation reflected back by the bottom 124 of the pan/cookware 110, is taken into account in this measurement as well.

The intensity of the infrared radiation recorded by the sensor 104, 308 depends on the details of the construction because preferably no optical elements such as focusing lenses are used. The diameter and height of an enclosure 116, for example an aluminum enclosure, in the proximity of the LEDs 107, 307 and the sensor 104, 308 as well as the distance between the sensor 104, 308 and the ceramic glass plate of the hob 112 are well defined. The central illumination provided by the LEDs 107, 307 indicates the middle of the hob at which the temperature of the cookware 110 is measured. Preferably, in the absence of cookware, these LEDs blink when the hob is turned on. Once the presence of a pan 110 is detected, the LEDs are automatically turned off to prevent the temperature measurement to be influenced.

In order to evaluate the emissivity of the cookware 110, the infrared sensor 104, 308 first needs to be calibrated. This is required by the finite manufacturing tolerances of the receiver and the emitter diodes. For the purpose of calibration, a reference setup has been constructed which features identical geometrical dimensions and arrangement of every component of an actual stove. The sensor 104, 308 is calibrated by means of a black body radiator, the emitting surface of which is calibrated between 50° C. and 350° C. to a precision of 0.1° C. The sensor is calibrated for example precisely at a temperature of 150° C., this calibration providing the scale factor relating the sensor response to the incident radiation.

In the actual operation of a stove, as soon as the hob is turned on and a pan 110 is present, the infrared measurement system becomes active.

In a first step, the sensor value provided by the second amplifier stage 302 is recorded for a first rough temperature measurement.

In a second step, a reference value for the reflectance of the pan bottom 124 is set for the first amplifier stage 301.

In a third step, the infrared LEDs 114, 312 are then switched on and the actual reflectance as provided by the first amplifier stage 301 is recorded.

In a fourth step, the reference value is then subtracted from the measured reflectance by the microprocessor 304.

In a fifth step, the emissivity of the pan bottom, which is simply given by 1- reflectance in percent, is thus calculated for a temperature range of typically 20 – 250° C.

This measurement cycle is continuously repeated during the whole period of time in which the stove is switched on. This permits accurate adjustment of the temperature measurement to any change of the emissivity of the cookware 110, for example when the latter is shifted in position on the hob.

As a result of heat conduction from the bottom 124 of the cookware 110 to the hob 112, the latter increasingly emits thermal radiation with increasing temperature. In order to compensate for this background radiation, the temperature of the ceramic glass plate of the hob 112 is measured with a temperature sensor 102, 306, such as a PT1000 thermistor, mounted underneath the plate.

The temperature of the bottom 124 of the pan is then evaluated by the microprocessor 304 which takes into account (1) the transmittance of the ceramic glass plate, (2) the thermal radiation emitted by the ceramic glass plate, evaluated by Planck’s radiation law from its now known temperature, (3) the radiation emitted by the bottom of the pan and corrected for its emissivity, related with its temperature again through Planck’s law.

In case the cookware 110 is not well placed above the infrared sensor 104 of the hob 112, the latter could in principle fail to measure the emitted radiation correctly, as a result of which the cookware might overheat. In order to prevent this from occurring, an alternative temperature measurement may be used with up to nine temperature sensors 102 located underneath the ceramic glass plate 112, depending on various needs of the embodiment. These temperature sensors 102 provide information about measured temperatures. This information is used for abnormal temperature protection of the induction coils 106 and indirectly of the cookware 110. Optionally, any of these temperature sensors records a temperature value above the one indicated by the infrared measurement system 130, the temperature control henceforth works with this higher value.

The invention permits the temperature of the bottom 124 of the cookware 110 to be monitored by the infrared measurement system 130 also in the power control mode. This includes a safety provision, wherein the power is reduced when the bottom 124 gets too hot. This active protection against overheating functions even when the cookware 110 and the ceramic glass hob 112 are spatially separated, so that no direct thermal contact exists between the two.

A technical description of the measurement procedure includes the following steps. The system comprises ten machine states numbered from 0 to 9.

The cycle time of each of these ten machine states is 100 msec, amounting to a total measurement time of 1 sec (10 x 100 ms = 1 sec). Four auto-ranging steps of amplifier stages 301 and 302 are carried out at states 0 (0 ms), 2 (200 ms), 4 (400 ms) and 6 (600 ms) in order to determine the proper amplification factor for the relevant signal strength at each state. At state 1, 3, 5 and 8, i.e. after 100, 300, 500 and 800 ms, no action is taken. Additionally, at state 6 the reference value for the emission is recorded for the first amplifier stage 301. At state 7, the evaluation cycle of the emissivity is made wherein the infrared LEDs 114, 312 are switched on and a series of 50 measurements of the first amplifier stage 301 are taken within 5 msec. The highest value of this measurement series is used for the calculation of the difference with the previously set reference value. From this difference, the emissivity is determined.

At state 9 (900 ms), a sufficiently long waiting time after state 7 in order to rule out any influence of the infrared reflectivity measurement on the temperature measurement (due to low pass filter capacitances, a short pause must be taken after the process of detecting the emission value, during which higher signal levels must be expected, before infrared measurements can be performed again. The temperature of the bottom 124 of the cookware 110 is calculated from the emissivity, the temperature of the temperature sensors 102, the ceramic glass temperature transmitted for example by the RS485 115, 305, and from a scaled total value. The latter is given by a multiplication factor of the output value of the second amplifier stage 302, weighted by the total amplification of both amplifier stages. This output value is again obtained from the average of 200 measurements taken at 100 µsec intervals, adding up to a total of 20 msec (200 x 100 µsec = 20 msec).

Further, the invention should be considered as comprising all possible combinations of every feature described in the instant specification, appended claims, and/or drawing figures which may be considered new, inventive and industrially applicable.

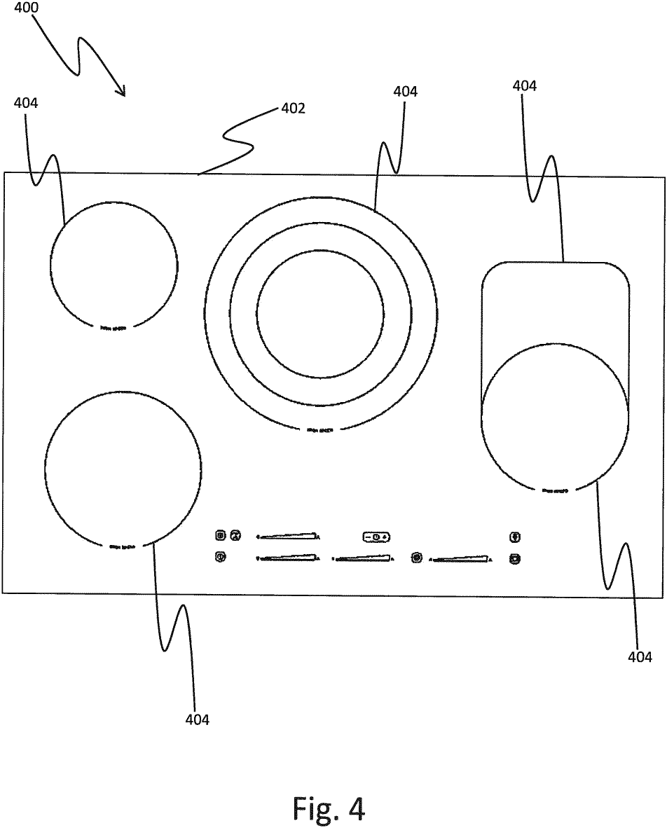

Referring now to FIG. 4, a multi-hob cooking kitchen island 400 of the invention includes a work surface 402 into which a plurality of cooking hobs 404 are integrated wherein at least one has the temperature measurement system of the invention integrated therein.

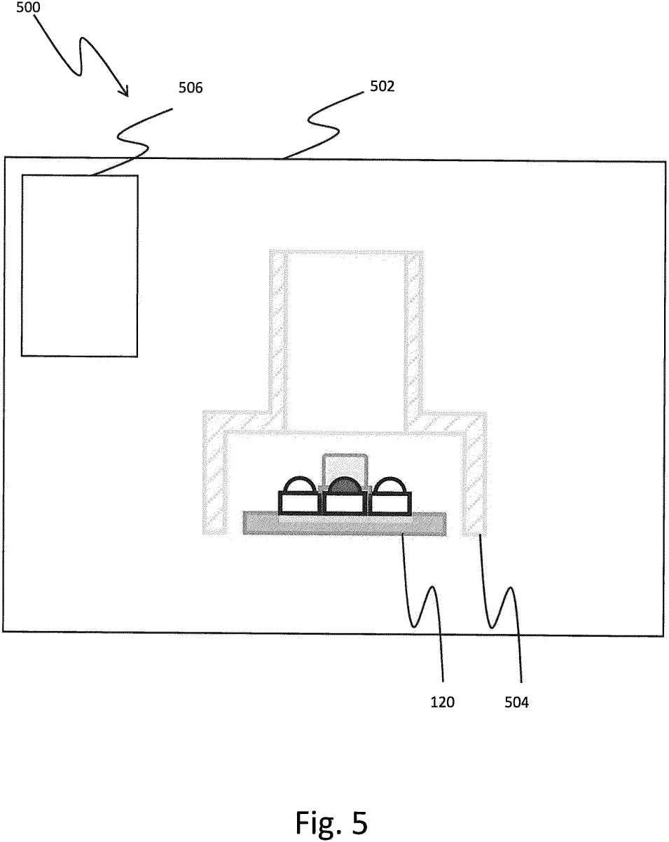

Referring now to FIG. 5, in another embodiment, a retrofit kit 500 is provided in packaging 502. This kit 500 includes the printed circuit board 120 containing the sensors and control electronics of FIG. 1B of the invention mounted in a housing 504 adapted to be attached at a central location below the ceramic glass hob 112 of an induction coil cooking system that was manufactured without such a temperature sensor. The kit 500 includes instructions 506 for installation, including retrofit wiring instructions, enabling connection to the existing convention control knob. The kit 500 is pre-configured to fit on induction cooking systems by model number year of manufacture given that each conventional induction cooking system is different in some way, and may have a ceramic glass hob with different reflectivity and transmissivity or other characteristics. Where the original design of the ceramic glass hub includes a ceramic glass hub that is not compatible with the temperature sensor of the invention, optionally, a replacement hob is provided in the kit.

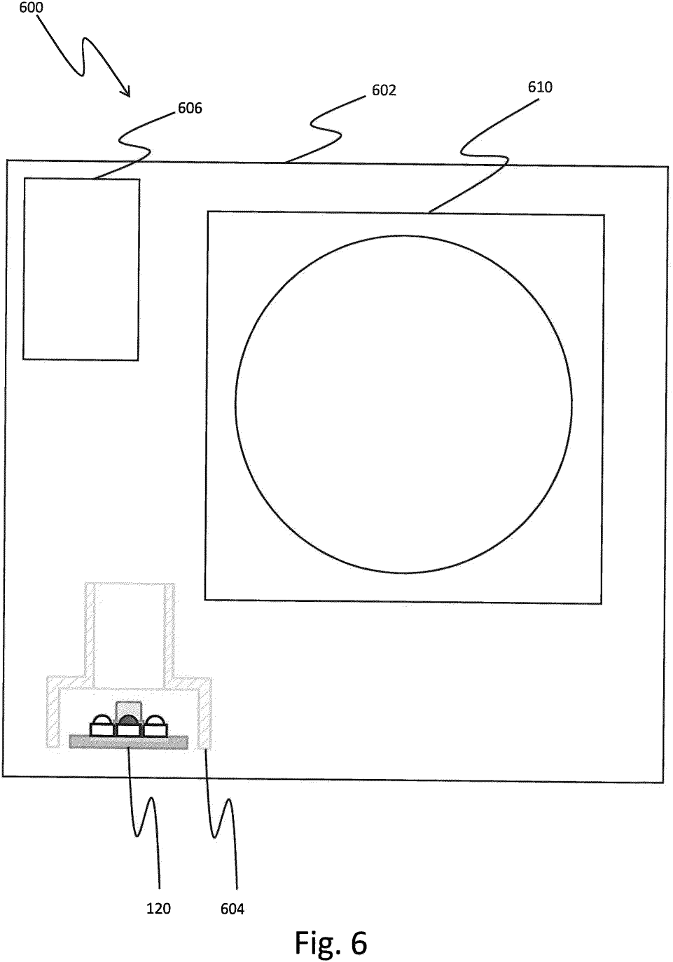

Referring now to FIG. 6, in another embodiment, a retrofit kit 600 is provided in packaging 602. This kit 600 is essentially identical to the kit 500 of FIG. 4, except that a replacement ceramic glass hob is provided as a retrofit module together with the printed circuit board containing the sensors and control electronics of FIG. 1B of the invention mounted in a housing 604. Instructions 606 are also provided in the packaging 602.

It should be appreciated that the particular implementations shown and herein described are representative of the invention and its best mode and are not intended to limit the scope of the present invention in any way.

The invention may be summarized by the following feature sets:
1. A system for induction cooking adapted for the remote measurement of the temperature of cookware, the system comprising at least one infrared sensor adapted for measuring the thermal radiation emitted by the bottom of the cookware, calibrated for estimated emissivity of the cookware using the input of a reflectivity measurement of the bottom of the cookware and optionally taking into account the temperature of the ceramic glass plate of the hob.
2. The system of feature set 1, wherein spectral transmissivity of the ceramic glass of the ceramic glass hob, as provided by the hob manufacturer, is taken into account in the temperature measurement.
3. The system of feature set 1, wherein emissivity of the cookware is continuously evaluated.
4. The system of feature set 3, wherein the emissivity of cookware is determined by infrared LEDs located close to the infrared sensor.
5. The system of feature set 1, wherein the at least one infrared sensor is mounted underneath the ceramic glass plate of the hob together with at least a thermistor adapted for compensating for temperature characteristics of the infrared sensor.
6. The system of feature set 5, wherein the at least one infrared sensor is mounted in an enclosure, preferably made from aluminum, which protects the infrared measurement system from thermal and electromagnetic interference.
7. The system of feature set 6, wherein the sensor is a photodiode which is preferably highly sensitive at a wavelength of 2.3 µm.
8. The system of feature set 6, wherein the infrared sensor and any additional devices are mounted on a printed circuit board, the printed circuit board further comprising
   a. the control electronics, and
   b. a RS485 interface.
9. The system of feature set 1, wherein the at least one infrared sensor is mounted underneath the ceramic glass plate of the hob together with at least one visible light emitting diode indicating the center of the hob for easier positioning of the cookware.
10. The system of feature set 9, wherein the at least one infrared sensor is mounted so as to be isolated from infrared light sources other than that of the object whose temperature is to be measured, particularly sources which vary in intensity over time.
11. The system of feature set 9, wherein the infrared sensor and any additional devices are mounted on a printed circuit board, the printed circuit board further comprising
   a. the control electronics, and
   b. a RS485 interface.
12. The system of feature set 1, wherein the at least one infrared sensor is mounted underneath the ceramic glass plate of the hob together with at least one infrared light emitting diode adapted for measuring the emissivity of the cookware.
13. The system of feature set 12, wherein the infrared sensor and any additional devices are mounted on a printed circuit board, the printed circuit board further comprising
   a. the control electronics, and
   b. a RS485 interface.
14. The system of feature set 1, wherein clockwise or counterclockwise rotation of a rotary knob from an off position changes the mode of operation and the power level from power control to temperature control.
15. The system of feature set 14, wherein temperature can be continuously set in this mode in the range from 70° C. to 250° C.
16. A system comprising one of a multi-hob cooking kitchen island, a table top induction cooker, a built-in induction cooker with one hob, a built-in induction cooker with more than one hob under one glass ceramic plate, and a standard induction cooker with one or more hobs, comprising at least one system of claim 1.
17. A method for induction cooking, wherein the temperature of the cookware is remotely measured by means of at least one infrared sensor adapted to receive thermal radiation and reflected light from the bottom of the cookware, the method including
   a. positioning the cookware in the center of the hob indicated by at least one visible light emitting diode, and
   b. continuously determining the emissivity of the bottom of the cookware by monitoring the reflected intensity from at least one infrared light emitting diode, and
   c. continuously compensating for the thermal radiation emitted by the glass ceramic plate of the hob by measuring its temperature with a thermistor.
18. A retrofit kit permitting installation of the system for induction cooking of feature set 1 in a conventional induction cooking arrangement, the kit optionally enclosed in packaging and including:
   a. a printed circuit board containing the sensors and control electronics mounted in a housing adapted to be attached at a central location below a ceramic glass hob of the conventional induction cooking arrangement; and
   b. instructions for installation, including retrofit wiring instructions, enabling connection to the existing convention control knob.
19. A retrofit kit permitting installation of the system for induction cooking of feature set 1 in a conventional induction cooking arrangement with an incompatible ceramic glass hob, the kit optionally enclosed in packaging and including:
   a. a retrofit module including the printed circuit board containing the sensors and control electronics mounted in a housing and attached at a central location below a replacement ceramic glass hob; and
   b. instructions for installation, including retrofit wiring instructions, enabling connection to the existing convention control knob.
20. A retrofitted multi-hob cooking kitchen island comprising at least one kit of feature set 18 or 19.

As will be appreciated by skilled artisans, the present invention may be embodied as a system, a device, or a method.

Moreover, the system contemplates the use, sale and/or distribution of any goods, services or information having similar functionality described herein.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Additional features and functionality of the invention are described in the claims appended hereto. Such claims are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

What is claimed is:

1. A system for induction cooking adapted for the remote measurement of the temperature of cookware, the system comprising at least one infrared sensor adapted for measuring the thermal radiation emitted by the bottom of the cookware, calibrated for estimated emissivity of the cookware using the input of a reflectivity measurement of the bottom of the cookware and taking into account the temperature of the ceramic glass plate of the hob.

2. The system of claim 1, wherein spectral transmissivity of the ceramic glass of the ceramic glass hob, as provided by the hob manufacturer, is taken into account in the temperature measurement.

3. The system of claim 1, wherein emissivity of the cookware is continuously evaluated.

4. The system of claim 3, wherein the emissivity of cookware is determined by infrared LEDs located close to the infrared sensor.

5. The system of claim 1, wherein the at least one infrared sensor is mounted underneath the ceramic glass plate of the hob together with at least a thermistor adapted for compensating for temperature characteristics of the infrared sensor.

6. The system of claim 5, wherein the at least one infrared sensor is mounted in an enclosure, preferably made from aluminum, which protects the infrared measurement system from thermal and electromagnetic interference.

7. The system of claim 6, wherein the sensor is a photodiode which is preferably highly sensitive at a wavelength of 2.3 µm.

8. The system of claim 6, wherein the infrared sensor and any additional devices are mounted on a printed circuit board, the printed circuit board further comprising
a. the control electronics, and b. a RS485 interface.

9. The system of claim 1, wherein the at least one infrared sensor is mounted underneath the ceramic glass plate of the hob together with at least one visible light emitting diode indicating the center of the hob for easier positioning of the cookware.

10. The system of claim 9, wherein the at least one infrared sensor is mounted so as to be isolated from infrared light sources other than that of the object whose temperature is to be measured, particularly sources which vary in intensity over time.

11. The system of claim 9, wherein the infrared sensor and any additional devices are mounted on a printed circuit board, the printed circuit board further comprising
a. the control electronics, and
b. a RS485 interface.

12. The system of claim 1, wherein the at least one infrared sensor is mounted underneath the ceramic glass plate of the hob together with at least one infrared light emitting diode adapted for measuring the emissivity of the cookware.

13. The system of claim 12, wherein the infrared sensor and any additional devices are mounted on a printed circuit board, the printed circuit board further comprising
a. the control electronics, and
b. a RS485 interface.

14. The system of claim 1, wherein clockwise or counterclockwise rotation of a rotary knob from an off position changes the mode of operation and the power level from power control to temperature control.

15. The system of claim 14, wherein temperature can be continuously set in this mode in the range from 70° C. to 250° C.

16. A system comprising one of a multi-hob cooking kitchen island, a table top induction cooker, a built-in induction cooker with one hob, a built-in induction cooker with more than one hob under one glass ceramic plate, and a standard induction cooker with one or more hobs, comprising at least one system of claim 1.

17. A method for induction cooking, wherein the temperature of the cookware is remotely measured by means of at least one infrared sensor adapted to receive thermal radiation and reflected light from the bottom of the cookware, the method including
a. positioning the cookware in the center of the hob indicated by at least one visible light emitting diode, and
b. continuously determining the emissivity of the bottom of the cookware by monitoring the reflected intensity from at least one infrared light emitting diode, and
c. continuously compensating for the thermal radiation emitted by the glass ceramic plate of the hob by measuring its temperature with a thermistor.

18. A retrofit kit permitting installation of the system for induction cooking of claim 1 in a conventional induction cooking arrangement, the kit optionally enclosed in packaging and including:
a. a printed circuit board containing the sensors and control electronics mounted in a housing adapted to be attached at a central location below a ceramic glass hob of the conventional induction cooking arrangement; and
b. instructions for installation, including retrofit wiring instructions, enabling connection to the existing convention control knob.

19. A retrofit kit permitting installation of the system for induction cooking of claim 1 in a conventional induction cooking arrangement with an incompatible ceramic glass hob, the kit optionally enclosed in packaging and including:
a. a retrofit module including the printed circuit board containing the sensors and control electronics mounted in a housing and attached at a central location below a replacement ceramic glass hob; and b. instructions for installation, including retrofit wiring instructions, enabling connection to the existing convention control knob.

20. A retrofitted multi-hob cooking kitchen island comprising at least one retrofit kit of claim 19.
